(19) United States
(12) Patent Application Publication
(10) Pub. No.: US 2026/0359410 A1
(43) Pub. Date: Nov. 12, 2026

(54) ZERO-TRUST VAULT FRAMEWORK WITH EPHEMERAL ACCESS

(71) Applicant: Bank of America Corporation, Charlotte, NC (US)

(72) Inventors: Vinodhini Paramasivan, Chennai (IN); Ambika Shanmugam, Chennai (IN); Durga Prasad Kutthumolu, Hyderabad (IN); A Subathra, Chennai (IN)

(21) Appl. No.: 19/204,818

(22) Filed: May 12, 2025

(51) Int. Cl. G06F 21/32; G06F 21/31

(52) U.S. Cl. CPC G06F 21/32; G06F 21/316

(57) ABSTRACT

A system for preventing execution of anomalous executables within a cloud computing environment includes a distributed ledger technology (“DLT”). The DLT may collect and verify the user data. The system may include an artificial intelligence (“AI”) model operable to dynamically generate an algorithm. The system may include a temporary ephemeral vault that holds temporary ephemeral credentials. The system may include a zero-trust data vault. The zero-trust data vault may gatekeep access to the cloud computing system. The user may access the system via the temporary ephemeral vault for a predetermined session. The system may further include a second DLT. The second DLT may record feedback data. The second DLT may refine the zero-trust data vault based on the refined data.

### FIELD OF TECHNOLOGY

Aspects of the disclosure relate to multi-cloud computing systems.

### BACKGROUND OF THE DISCLOSURE

The usage of cloud computing systems is increasing. Typical cloud computing systems use static passwords to prevent users of malicious intent from compromising the cloud computing system. Static password usage causes vulnerability to the cloud computing system.

Current cloud computing systems are also vulnerable in multiple ways. Security breaches to cloud computing systems include spoofing, tampering, repudiation, information disclosure, distributed denial of service (“DDoS”) and/or elevation of privileges, which can also be referred to as “STRIDE.”

Spoofing of data may include a person of malicious intent disguising an email address, sender name, phone number and/or website uniform resource locator (“URL”). Such a person may attempt to impersonate another user or system component in order to obtain access into a system. Spoofing of data may include a user of malicious intent changing a single letter, symbol or number of a legitimate email address, sender name, phone number and/or website URL and using the modified illegitimate email address, etc. to disguise the user of malicious intent as a legitimate user.

Tampering may be understood to refer to unauthorized alteration of data. A user of malicious intent may access a system and tamper with the files. The user may delete data encrypt data and/or alter the data in any other way.

Data repudiation may be understood to refer to a party denying or disputing the validity of a dataset or actions taken out of network. The party may claim that the dataset or actions taken out of the network did not originate from the user. Therefore, repudiation can undermine accountability and traceability of the dataset or actions taken out of the network.

Information disclosure of data may be understood to refer to an unintended exposure of privileged or sensitive data to unauthorized parties.

Distributed Denial of Service (“DDoS”) may be understood to be refer to an operation that overwhelms a system and thereby disrupts the availability of the system services.

Elevation of privileges may be understood to refer to a user of malicious intent exploiting a system’s vulnerability to obtain a higher level of access permissions within the system. The user of malicious intent can perform malicious and/or unauthorized permissions using the higher level of access permission.

Therefore, it would be desirable to create systems and methods to prevent security breaches within a cloud environment.

It would be further desirable for the system to include a zero-trust data vault.

It would be yet further desirable for the system to maintain ephemeral access within the zero-trust data vault.

### SUMMARY OF THE DISCLOSURE

Apparatus, methods and systems for a zero-trust vault framework with ephemeral access is provided.

The system may include a distributed ledger technology (“DLT”). The DLT may be a system that includes a plurality of nodes without a single centralized node. Data stored on one of the plurality of nodes may be accessible from any of the other nodes within the DLT. A majority of nodes within the DLT may be required to verify user data in order for the user data to be labeled “verified.” The verification process may include determining whether the user data is associated with the user requesting access into the system.

The DLT may receive an electronic indicator of a request. The request may have been transmitted from a mobile device associated with a user. The request may include a request to access the system. The system may be a cloud computing system, a multi-cloud computing system and/or any other suitable system. The system may be a secure system.

The system may authenticate the user. The DLT may collect data about the user. The collected data may be used to authenticate the user. The collected data may be a set of anthropometric data, a set of platform data and/or any other suitable data. Anthropometric data may be understood to refer to data about a human body. The anthropometric data may include a measurement of the user’s height, weight, waist, body mass index (“BMI”) and/or any other suitable measurement. The anthropometric data may also include biometric data. The biometric data may include an iris scan, a fingerprint scan, a retina scan, a facial scan, a keystroke model, a vein recognition scan, and/or any other suitable biometric data.

The collected data may include the set of platform data. The platform data may be data about the user. The platform data may be digital cosmos platform data. A digital cosmos platform, for purposes of the application, may be understood to refer to an advanced cloud computing space. The platform data may be metaverse platform data. A metaverse platform may be understood to refer to a virtual, interconnected digital space through which users interact. As such, the platform data about the user may include spatial data, user interaction data, system response data and/or any other suitable data relating to, or about, the user.

Upon collection of the set of anthropometric data and/or the set of platform data, the system may verify the set of anthropometric data and/or the set of platform data. The DLT may verify the set of anthropometric data and/or the set of platform data.

The verification process may include determining whether a channel through which the system received the collected data is a valid channel. The verification process may include confirming that the received set of anthropometric data matches the user of the received set of platform data. Upon verification of the data, from a majority of the nodes within the DLT, the user may be authenticated.

The system may further include an artificial intelligence (“AI”) model. In some embodiments, the system may include a randomness generator. The AI model and/or the randomness generator may, based on the verified data, dynamically generate an algorithm for the user. The algorithm may be a dynamic algorithm. The algorithm may be based on the set of anthropometric data and/or the set of platform data. The algorithm may be specific to the user. The algorithm may change dynamically. The algorithm may be a temporary algorithm. As such, each time a user requests access to the system, the system may generate a new algorithm.

The AI model and/or the randomness generator may generate, by the algorithm, temporary ephemeral credentials for the user. Temporary ephemeral credentials may be understood to refer to temporary authentication tokens that provide time-bound access to a system.

The system may include a temporary ephemeral vault. The temporary ephemeral vault, for purposes of the application, may be understood to refer to a memory vault with a time bound authentication for verified user sessions. The temporary ephemeral vault may hold the temporary ephemeral credentials.

The system may include a zero-trust data vault. The zero-trust data vault may gatekeep access to the cloud computing system. The user may access the system through the zero-trust data vault. A zero-trust data vault may refer to a vault that does not trust any user. As such, the zero-trust data vault may be accessed using the temporary ephemeral vault, which provides the zero-trust data vault with continuously verified user credentials. A zero-trust data vault may refer to a secure, isolated database designed to store, manage and use sensitive data. The zero-trust data vault may use the temporary ephemeral credentials as the authorization and authentication for the user accessing the zero-trust data vault.

In some embodiments, the zero-trust data vault may include a limited privilege access. The zero-trust data vault may allow the user to access the system according to a level associated with the user. Each user may be assigned to a predetermined permissions level. Access within the system may be according to the assigned, predetermined permissions level. The limited access may allow the user to access specific data and resources. As such, the zero-trust data vault may prevent security breaches within the system.

The zero-trust data vault may be limited to a predetermined session. The predetermined session may have a specific start time and a specific end time. The predetermined session may be limited by a time limit, a start time, an end time, a detected anomaly, any suitable combination of the above factors, and/or any other suitable factor. As such, the predetermined session may end after a predetermined amount of time. In an example, the session may be terminated upon detection of an anomaly. In another example, the session may time out after the predetermined amount of time has lapsed or upon an anomaly detection. The temporary ephemeral credentials may enable access to the zero-trust data vault for a predetermined session.

The DLT may continuously compare the algorithm to a current set of anthropometric data and a current set of platform data relating to the user. The user may be continuously monitored to retrieve the current set of anthropometric data and/or the current set of platform data. The current set of anthropometric data and/or the current set of platform data may be continuously updated.

The DLT may dynamically evolve the algorithm. The algorithm may be dynamically evolved based on the current set of anthropometric data and/or the current set of platform data. The temporary ephemeral vault and the user access may be continuously adjusted based on the dynamically evolved algorithm. As such, upon an anomaly detection, the temporary ephemeral vault may be decommissioned.

The temporary ephemeral vault may, upon verification of the anthropometric data and the platform data, may enable the user access into the temporary ephemeral vault. The temporary ephemeral vault may enable the user to access the zero-trust data vault via the temporary ephemeral vault. The temporary ephemeral vault may track interactions of the user within the zero-trust data vault.

The DLT and the zero-trust data vault may be further operable to dynamically adjust user interactions within the zero-trust data vault. The user interactions may be dynamically adjusted based on the dynamically evolved algorithm. Dynamically adjusting the user interactions of the user access may include adjusting the data the user is accessing, adjusting actions the user is performing within the system and/or any other additional adjustments.

The temporary ephemeral vault may be securely decommissioned upon termination of the temporary ephemeral vault. The temporary ephemeral vault may be decommissioned upon an anomaly detection. The temporary ephemeral vault may be decommissioned upon a time limit. The temporary ephemeral vault may be decommissioned for any other suitable purpose.

The system may further include a second DLT. The second DLT may be instantiated upon the decommissioning of the vault. The second DLT may record feedback data generated by the user during the predetermined session. The feedback data may include the temporary ephemeral credentials, the temporary ephemeral vault, the user interactions and any other suitable data. The second DLT may record the feedback data and store the feedback data in memory. The second DLT may use the feedback data during subsequent usage of the system.

The second DLT may receive feedback data about the usage of the temporary ephemeral vault. The feedback data may include when the temporary ephemeral vault was decommissioned. The feedback data may include the reason the temporary ephemeral vault was decommissioned. The feedback data may include data that the user accessed while using the temporary ephemeral vault. The feedback data may include any other suitable information about the user and/or the temporary ephemeral vault.

The second DLT may further refine the zero-trust data vault based on the feedback data. Refinements may include shorter time sessions for the user and/or any other suitable refinements. Refinements may include refining security characteristics. The zero-trust data vault may be refined for future usage for the current user and/or any other suitable user.

### BRIEF DESCRIPTION OF THE DRAWINGS

The objects and advantages of the invention may be apparent upon consideration of the following detailed description, taken in conjunction with the accompanying drawings, in which like reference characters refer to like parts throughout, and in which:

FIG. 1 shows an illustrative diagram in accordance with the principles of the disclosure;

FIG. 2 shows another illustrative diagram in accordance with the principles of the disclosure;

FIG. 3 shows yet another illustrative diagram in accordance with the principles of the disclosure; and

FIG. 4 shows still another illustrative diagram in accordance with the principles of the disclosure.

### DETAILED DESCRIPTION OF THE DISCLOSURE

Apparatus, methods and systems for a zero-trust framework with ephemeral access are provided.

Methods may include receiving a request from a user to log into a system. The request may be received from a mobile device associated with the user. The system may be a cloud computing system, a multi-cloud computing system and/or any other suitable system.

Methods may include collecting a set of anthropometric data about the user. Anthropometric data may include measurements of the human body including size, shape and composition. Anthropometric data may include a user’s height, weight, waist size, body mass index (“BMI”) and/or any other suitable measurements. In some embodiments, anthropometric data may further include biometric data about the user. Biometric data may include an iris scan, a fingerprint scan, a retina scan, a facial scan, a keystroke model, a vein recognition scan and/or any other suitable biometric data.

Methods may include retrieving a set of platform data about the user. The set of platform data may be retrieved from a platform at which the user is operating. The platform data may be digital cosmos platform data or metaverse platform data. A digital cosmos platform may be understood to refer to a cloud computing platform. A metaverse platform may be understood to refer to a virtual and interconnected digital space. The user may have operated at the digital cosmos platform and/or the metaverse platform. As such, the platform data about the user may include user interaction data, spatial data, system response data and/or any other suitable data relating to, and/or about, the user.

Methods may include verifying the set of anthropometric data and/or the set of platform data. A distributed ledger technology (“DLT”) may verify the data. The DLT may be a technological infrastructure that allows access, validation and record updating across a networked database. The DLT may be maintained by a network of nodes. Each of the nodes may have a copy of a ledger corresponding to the DLT. Each of the nodes may validate the information.

A majority of nodes within the DLT may be required to verify the set of anthropometric data and/or the set of platform data in order for the data to be verified. The verification process may include verifying a channel through which the data was received. The verification process may include verifying that the set of anthropometric data and/or the set of platform data is associated with the user. The verification process may include confirming that the set of anthropometric data corresponds to the set of platform data.

Methods may include, based on the verified data, dynamically generating an algorithm for the user. The algorithm may be generated using one or more randomness generators. The algorithm may be generated using one or more artificial intelligence (“AI”) models. The algorithm may be a dynamic algorithm.

Methods may include generating, by the algorithm, temporary ephemeral credentials for the user. The temporary ephemeral credentials may be generated and verified based on the algorithm. The temporary ephemeral credentials may enable a predetermined session on a zero-trust data vault.

Methods may include instantiating a temporary ephemeral vault. The temporary ephemeral vault may hold the temporary ephemeral credentials. The temporary ephemeral vault may be a one-time usage vault. The temporary ephemeral vault may be specific for the user.

Methods may include comparing the algorithm to a current set of anthropometric data and/or a current set of platform data relating to the user. The current set of anthropometric data and/or the current set of platform data may be continuously updated. The current set of anthropometric data and/or the platform data may be retrieved from the user’s mobile device, a system associated with the user and/or any other suitable location.

Methods may include dynamically evolving the algorithm. The algorithm may dynamically evolve based on the current set of anthropometric data and/or the current set of platform data. The algorithm may be used to authenticate the user into the system. The algorithm may dynamically evolve using the AI model. The algorithm may dynamically evolve using the one or more randomness generators. Any other suitable hardware and/or software may be used for dynamically evolving the algorithm.

Methods may include, based on the verifying, enabling the user access into the temporary ephemeral vault. Upon verification of the user, the user may access the temporary ephemeral vault. The user may access the temporary ephemeral vault which may grant the user access into the zero-trust data vault.

Methods may include enabling the user access into the zero-trust data vault via the temporary ephemeral vault. The zero-trust data vault may be a channel by which the user accesses the system. The zero-trust data vault may allow the user to perform activities within the system. A zero-trust data vault may be understood to refer to a vault that continuously verifies the identity of the user, thereby “not trusting” any user. The temporary ephemeral credentials may be continuously verified, thereby allowing the user to access the zero-trust data vault. The zero-trust data vault may provide the user with secure data access and action tools within the system.

Methods may include tracking interactions of the user within the zero-trust data vault. User interactions may include data access, modifications and transactions. Tracking user interactions within the zero-trust data vault may include a real-time behavior analysis. The user interactions within the zero-trust vault may be monitored to determine if the user performs the appropriate actions.

Methods may include dynamically adjusting interactions of the user within the zero-trust data vault. The adjusting may be based on the continuously compared algorithm to the current set of anthropometric data and/or the current set of platform data. The adjusting may include adjusting access permissions and time durations. The adjustments may be based on the tracked user interactions. The adjustments may be based on the real-time behavior analysis within the vault. The adjustments may be based on the evolving algorithm. The adjusting may include allowing the user to access more data than the user was previously permitted to access. The adjustments may include allowing the user to access less data than the user was previously permitted to access. The adjustments may include a plurality of additional adjustments according to a user level and tracked interactions.

Methods may include securely decommissioning the temporary ephemeral vault upon termination of the temporary ephemeral vault. The temporary ephemeral vault may be decommissioned after the predetermined session. The predetermined session may be after a predetermined amount of time. The predetermined session may end upon a single anomaly detection. The predetermined session may end after a predetermined number of anomaly detections. Each temporary ephemeral vault may include session end times, anomaly detections or any other suitable reasons upon which the vault may be decommissioned. Anomalies may be detected within the data, the algorithm, the temporary ephemeral vault, the zero trust data vault and/or any other suitable location.

Methods may include recording feedback data generated by the predetermined session. The recording may be performed on a second DLT. The recorded feedback data may include authentication attempts, temporary ephemeral vault events, zero-trust data vault events and system actions. The recorded feedback data may be retrieved and used when the user logs into the system a subsequent time. The recorded feedback data may be used when the system requires additional information to verify a user. A behavior monitor may monitor the user’s behaviors within the zero-trust data vault.

Methods may include, based on the feedback data, refining the zero-trust data vault. Refinements may include refining the security characteristics within the zero-trust data vault. Refinements may include shorter time sessions for the user and/or any other suitable refinements. The zero-trust data vault may be refined for future usage for the current user and/or any other suitable user.

Systems and methods described herein are illustrative. Systems and methods in accordance with this disclosure may now be described in connection with the figures, which form a part hereof. The figures show illustrative features of system and method steps in accordance with the principles of this disclosure. It is to be understood that other embodiments may be utilized, and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Systems may omit features shown or described in connection with illustrative systems. Embodiments may include features that are neither shown nor described in connection with the illustrative systems. Features of illustrative systems may be combined. For example, an illustrative embodiment may include features shown in connection with another illustrative embodiment.

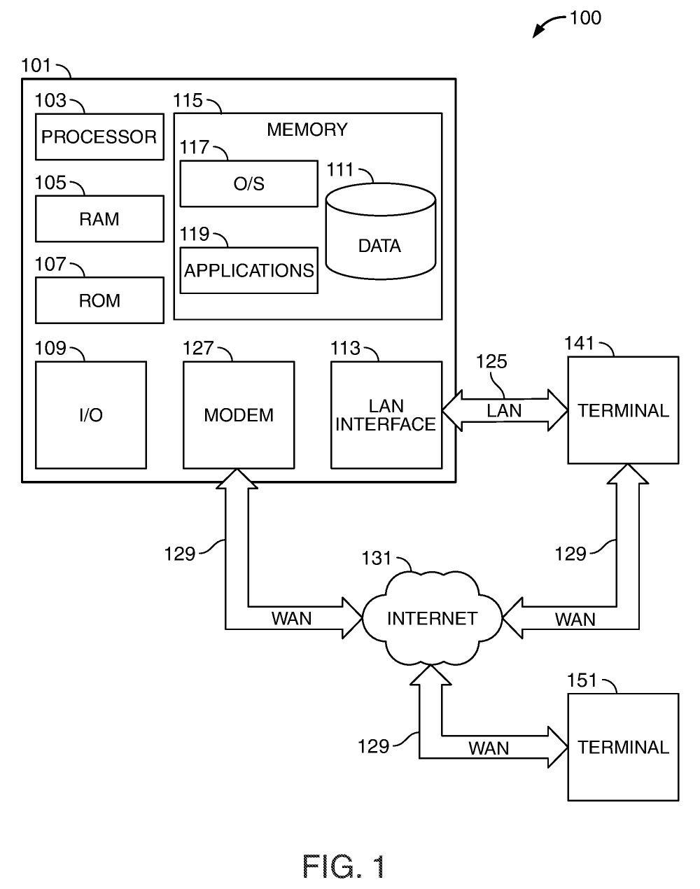

FIG. 1 shows an illustrative block diagram of apparatus 100 that includes computer 101. Computer 101 may alternatively be referred to herein as a “computing device.” Elements of apparatus 100, including computer 101, may be used to implement various aspects of the apparatus and methods disclosed herein. A “user” of apparatus 100 or computer 101 may include other computer systems or servers or computing devices, such as the program described herein.

Computer 101 may have one or more processors/ microprocessors 103 for controlling the operation of the device and its associated components, and may include RAM 105, ROM 107, input/output module 109, and a memory 115. Microprocessors 103 may also execute all software running on the computer 101—e.g., the operating system 117 and applications 119 such as an artificial intelligence implemented termination program and security protocols. Other components commonly used for computers, such as EEPROM or Flash memory or any other suitable components, may also be part of the computer 101.

Memory 115 may be comprised of any suitable permanent storage technology—e.g., a hard drive or other non-transitory memory. ROM 107 and RAM 105 may be included as all or part of memory 115. The memory 115 may store software including the operating system 117 and application(s) 119 (such as an artificial intelligence implemented termination program and security protocols) along with any other data 111 (e.g., historical data, configuration files) needed for the operation of the apparatus 100. Memory 115 may also store applications and data. Alternatively, some or all of computer executable instructions (alternatively referred to as “code”) may be embodied in hardware or firmware (not shown). The microprocessor 103 may execute the instructions embodied by the software and code to perform various functions.

The network connections/communication link may include a local area network (LAN) and a wide area network (WAN or the Internet) and may also include other types of networks. When used in a WAN networking environment, the apparatus may include a modem or other means for establishing communications over the WAN or LAN. The modem and/or a LAN interface may connect to a network via an antenna. The antenna may be configured to operate over Bluetooth, Wi-Fi, cellular networks, or other suitable frequencies.

Any memory may be comprised of any suitable permanent storage technology—e.g., a hard drive or other non-transitory memory. The memory may store software including an operating system and any application(s) (such as an artificial intelligence implemented termination program and security protocols) along with any data needed for the operation of the apparatus and to allow bot monitoring and IoT device notification. The data may also be stored in cache memory, or any other suitable memory.

An input/output (“I/O”) module 109 may include connectivity to a button and a display. The input/output module may also include one or more speakers for providing audio output and a video display device, such as an LED screen and/or touchscreen, for providing textual, audio, audiovisual, and/or graphical output.

In an embodiment of the computer 101, the microprocessor 103 may execute the instructions in all or some of the operating system 117, any applications 119 in the memory 115, any other code necessary to perform the functions in this disclosure, and any other code embodied in hardware or firmware (not shown).

In an embodiment, apparatus 100 may consist of multiple computers 101, along with other devices. A computer 101 may be a mobile computing device such as a smartphone or tablet.

Apparatus 100 may be connected to other systems, computers, servers, devices, and/or the Internet 131 via a local area network (LAN) interface 113.

Apparatus 100 may operate in a networked environment supporting connections to one or more remote computers and servers, such as terminals 141 and 151, including, in general, the Internet and “cloud”. References to the “cloud” in this disclosure generally refer to the Internet, which is a world-wide network. “Cloud-based applications” generally refer to applications located on a server remote from a user, wherein some or all of the application data, logic, and instructions are located on the internet and are not located on a user’s local device. Cloud-based applications may be accessed via any type of internet connection (e.g., cellular or Wi-Fi).

Terminals 141 and 151 may be personal computers, smart mobile devices, smartphones, IoT devices, or servers that include many or all of the elements described above relative to apparatus 100. The network connections depicted in FIG. 1 include a local area network (LAN) 125 and a wide area network (WAN) 129 but may also include other networks. Computer 101 may include a network interface controller (not shown), which may include a modem 127 and LAN interface or adapter 113, as well as other components and adapters (not shown). When used in a LAN networking environment, computer 101 is connected to LAN 125 through a LAN interface or adapter 113. When used in a WAN networking environment, computer 101 may include a modem 127 or other means for establishing communications over WAN 129, such as Internet 131. The modem 127 and/or LAN interface 113 may connect to a network via an antenna (not shown). The antenna may be configured to operate over Bluetooth, Wi-Fi, cellular networks or other suitable frequencies.

It will be appreciated that the network connections shown are illustrative and other means of establishing a communications link between computers may be used. The existence of various well-known protocols such as TCP/IP, Ethernet, FTP, HTTP, and the like is presumed, and the system can operate in a client-server configuration. The computer may transmit data to any other suitable computer system. The computer may also send computer-readable instructions, together with the data, to any suitable computer system. The computer-readable instructions may be to store the data in cache memory, the hard drive, secondary memory, or any other suitable memory.

Application program(s) 119 (which may be alternatively referred to herein as “plugins,” “applications,” or “apps”) may include computer executable instructions for an artificial intelligence implemented termination program and security protocols, as well as other programs. In an embodiment, one or more programs, or aspects of a program, may use one or more artificial intelligence/machine learning (“AI/ML”) algorithm(s).

Computer 101 may also include various other components, such as a battery (not shown), speaker (not shown), a network interface controller (not shown), and/or antennas (not shown).

Terminal 151 and/or terminal 141 may be portable devices such as a laptop, cell phone, tablet, smartphone, server, or any other suitable device for receiving, storing, transmitting and/or displaying relevant information. Terminal 151 and/or terminal 141 may be other devices such as remote computers or servers. The terminals 151 and/or 141 may be computers where a user is interacting with an application.

Any information described above in connection with data 111, and any other suitable information, may be stored in memory 115. One or more of applications 119 may include one or more algorithms that may implement features of the disclosure, and/or any other suitable tasks.

In various embodiments, the invention may be operational with numerous other general purpose or special purpose computing system environments or configurations. Examples of well-known computing systems, environments, and/or configurations that may be suitable for use with the invention in certain embodiments include, but are not limited to, personal computers, servers, hand-held or laptop devices, tablets, mobile phones, smart phones, other computers, and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, IoT devices, and the like.

Aspects of the invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network, e.g., cloud-based applications. In a distributed computing environment, program modules may be located in both local and remote computer storage media including memory storage devices.

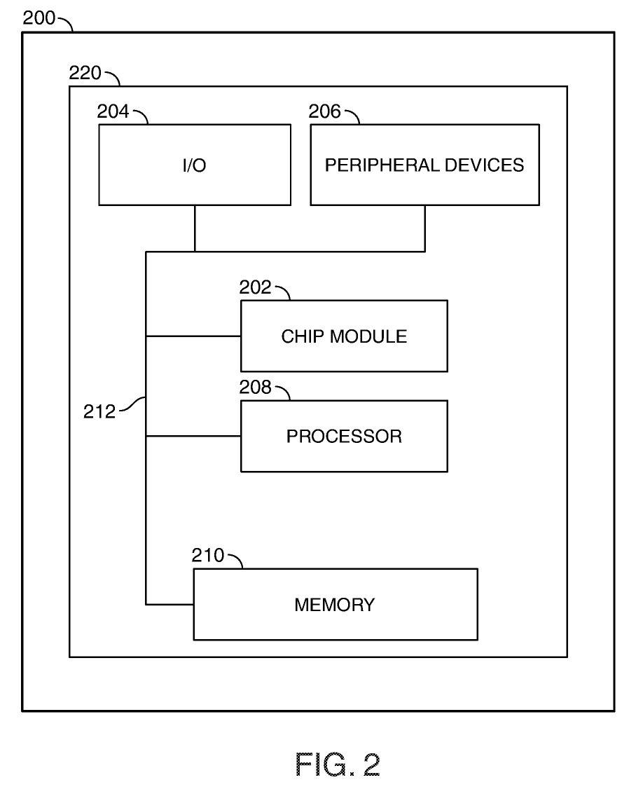

FIG. 2 shows illustrative apparatus 200 that may be configured in accordance with the principles of the disclosure. Apparatus 200 may be a server or computer with various peripheral devices 206. Apparatus 200 may include one or more features of the apparatus shown in FIGS. 1- 4. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device, a display (LCD, LED, OLED, etc.), a touchscreen or any other suitable media or devices, peripheral devices 206, which may include other computers, logical processing device 208, which may compute data information and structural parameters of various applications, and machine-readable memory 210.

Machine-readable memory 210 may be configured to store in machine-readable data structures: machine executable instructions (which may be alternatively referred to herein as “computer instructions” or “computer code”), applications, signals, recorded data, and/or any other suitable information or data structures. The instructions and data may be encrypted.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

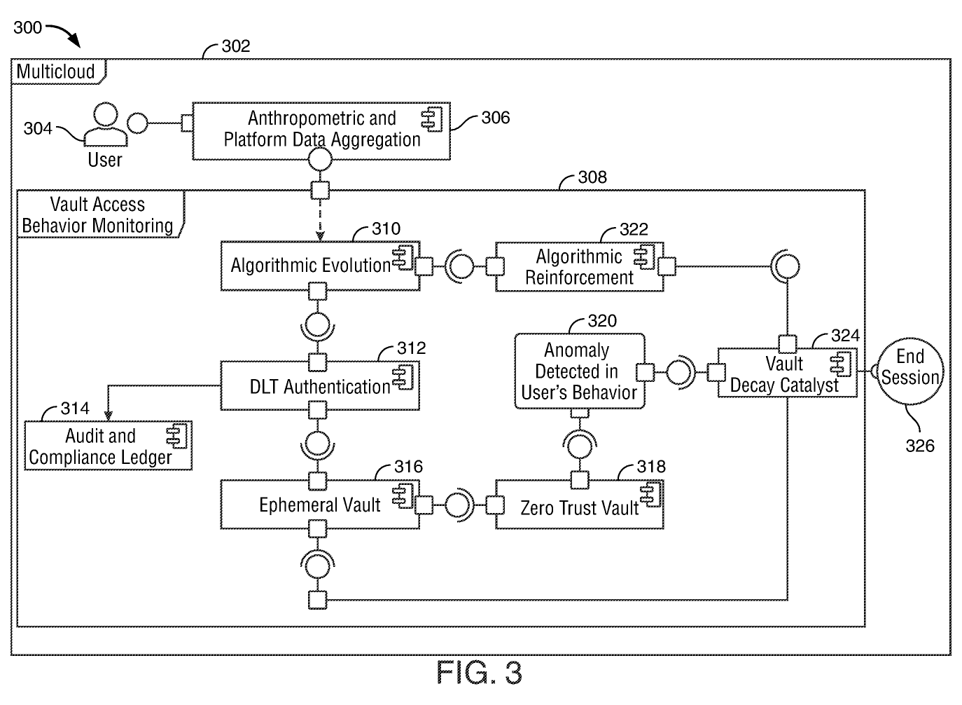

FIG. 3 shows illustrative flow diagram 300. User 304 may log into multi-cloud computing system 302. User 304 may request access into multi-cloud computing system 302. Multi-cloud computing system 302 may authenticate user 304. As such, user 304 may access multi-cloud computing system 302.

Multi-cloud computing system 302 may aggregate a set of anthropometric data and a set of platform data 306. The set of anthropometric data and the set of platform data 306 may be used to authenticate user 304. The set of anthropometric data and the set of platform data 306 may be aggregated from a user’s mobile device, from a system associated with the user and/or any other suitable location. User 304 may be authenticated based on the aggregated set of anthropometric data and set of platform data 306.

Upon authentication, multi-cloud computing system 302 may generate an algorithm, as shown at step 310. The algorithm may be a dynamically evolving algorithm. The algorithm may be reinforced, as shown at step 322. The algorithm may be a secure algorithm. A distributed ledger technology (“DLT”) may record the algorithm and the set of anthropometric data and the platform data 306 in an audit and compliance ledger, as shown at step 314.

Upon generation of the algorithm, DLT authentication 312 may generate temporary ephemeral credentials for user 304. Temporary ephemeral vault 316 may hold the temporary ephemeral credentials. Temporary ephemeral vault 316 may enable access to zero-trust data vault 318 for a predetermined session. Zero-trust data vault 318 may gatekeep access into multi-cloud computing system 302.

Temporary ephemeral vault 316 may be continuously monitored. Temporary ephemeral vault 316 may be decommissioned upon vault decay catalyst detection 324. Vault decay catalyst detection 324 may be an anomaly detection, as shown at step 320. Vault decay catalyst detection 324 may include the user using the system for greater than a predetermined amount of time. Vault decay catalyst detection 324 may be any other suitable detection. Upon vault decay catalyst detection 324, temporary ephemeral vault 316 may be decommissioned and the session may end, as shown at step 326.

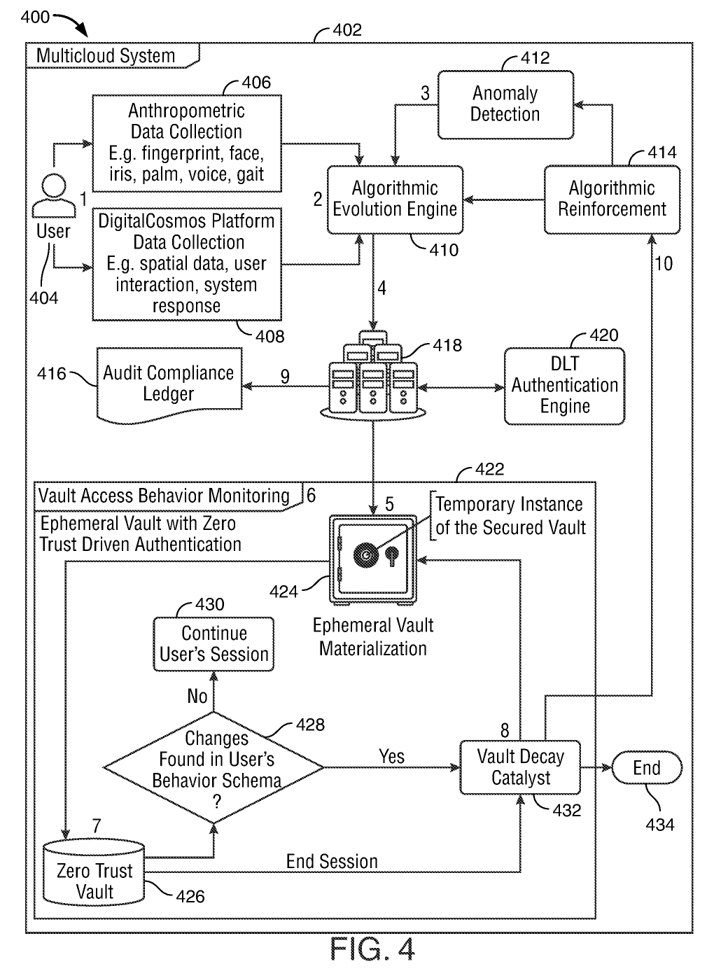

FIG. 4 shows illustrative flow diagram 400. Multi-cloud computing system 402 may include one or more features in common with multi-cloud computing system 302. Multi-cloud computing system 402 may be a cloud computing system, a multi-cloud computing system and/or any other suitable system. User 404 may include one or more features in common with user 304 in FIG. 3. User 404 may request access into multi-cloud computing system 402. Multi-cloud computing system 402 may verify user 404 prior to granting user 404 access into multi-cloud computing system 402.

Multi-cloud computing system 402 may collect a set of anthropometric data about the user, as shown at step 406. Anthropometric data may include fingerprint data, facial data, an iris scan, a palm scan, voice data, gait data and/or any other suitable data about user 404. Multi-cloud computing system 402 may collect a set of platform data about user 404, as shown at step 408. Platform data may include spatial data, user interaction data, system response data and/or any other suitable data about user 404.

Algorithmic evolution engine 410 may collect the set of anthropometric data and the set of platform data. Algorithmic evolution engine 410 may generate an algorithm for the user 404 based on the set of anthropometric data and the set of platform data. The algorithm may be a dynamically evolving algorithm. The algorithm may be continuously analyzed to prevent an anomaly within the system, as shown at step 412. The analysis of the algorithm may reinforce the algorithm, as shown at step 414.

Multi-cloud computing system 402 may compare the collected data and the algorithm on distributed ledger technology (“DLT”) 418. DLT 418 may include a DLT authentication engine 420 for authenticating the algorithm and user 404. DLT 418 may transmit a record of authentication attempts and vault events to an audience compliance ledger 416. Audience compliance ledger 416 may be a second DLT. Audience compliance ledger 416 may be separate from DLT 418.

Upon authentication of the algorithm and user 404, user 404 may be granted access into multi-cloud computing system 402. Interactions of user 404 within multi-cloud computing system 402 may be tracked using vault access behavior monitoring 422. User 404 may access multi-cloud computing system 402 via temporary ephemeral vault 424. Temporary ephemeral vault 424 may be a temporary instance of a secure vault. Temporary ephemeral vault 424 may allow user 404 to access zero-trust data vault 426.

User 404 may be monitored when accessing multi-cloud computing system 402 using zero-trust data vault 426. Multi-cloud computing system 402 may dynamically adjust access permissions and time durations to user 404 based on real-time behavior analysis and the evolving algorithm. Multi-cloud computing system 402 may perform a query that dynamically adjusts the access permissions. The query may include detecting changes found in user 404’s behavior schema, as shown at step 428. When a response to the query is yes, the user session may continue, as shown at step 430. When a response to the query is no, a vault decay catalyst may have been detected, as shown at step 432 and the user session may end, as shown at step 434.

Thus, methods and systems for a zero-trust vault framework with ephemeral access are provided. Persons skilled in the art may appreciate that the present invention can be practiced by other than the described embodiments, which are presented for purposes of illustration rather than of limitation. The present invention is limited only by the claims that follow.

What is claimed is:

1. A method for preventing an occurrence of an anomaly within a cloud computing system, the method comprising:
receiving a request from a user to log into the cloud computing system;
collecting a set of anthropometric data about the user;
retrieving a set of platform data about the user from a platform at which the user is operating;
verifying the set of anthropometric data and the set of platform data;
based on the set of anthropometric data and the set of platform data, dynamically generating an algorithm for the user;
generating, by the algorithm, temporary ephemeral credentials for the user;
instantiating a temporary ephemeral vault, said temporary ephemeral vault operable to hold the temporary ephemeral credentials that are operable to enable a predetermined session on a zero-trust data vault;
gatekeeping, with the zero-trust data vault, access to the cloud computing system;
continuously comparing the algorithm to a current set of anthropometric data and a current set of platform data relating to the user, said current set of anthropometric data and current set of platform data being continuously updated;
dynamically evolving the algorithm based on the current set of anthropometric data and the current set of platform data;
based on the verifying, enabling the user access into the temporary ephemeral vault;
enabling the user to access the zero-trust data vault via the temporary ephemeral vault;
tracking interactions of the user within the zero-trust data vault;
dynamically adjusting interactions of the user within the zero-trust data vault, the adjusting being based on the continuously compared algorithm to the current set of anthropometric data and the current set of platform data;
securely decommissioning the temporary ephemeral vault upon termination of the temporary ephemeral vault;
recording feedback data generated by the predetermined session, said feedback data comprising the temporary ephemeral credentials, the temporary ephemeral vault and the interactions of the user; and
based on the feedback data, refining security characteristics the zero-trust data vault.

2. The method of claim 1 wherein the set of anthropometric data includes measurement of a height of the user, a weight of the user, a waist size of the user and a body mass index (“BMI”) of the user.

3. The method of claim 1 wherein the set of anthropometric data includes biometric data, the biometric data including an iris scan, a fingerprint scan, a retina scan, a facial scan, a keystroke model and a vein recognition scan.

4. The method of claim 1 wherein the decommissioning of the temporary ephemeral vault is configured to be after either a predetermined amount of time or an anomaly detection.

5. The method of claim 1 wherein a distributed ledger technology (“DLT”) continuously compares the current set of anthropometric data and the current set of platform data to the algorithm.

6. The method of claim 1 wherein the interactions of the user include data access, modifications, real-time behavior analysis and transactions.

7. The method of claim 1 wherein the recording occurs on a second DLT and wherein the second DLT records authentication attempts, vault events and system actions.

8. The method of claim 1 wherein the platform is a digital cosmos platform.

9. The method of claim 1 wherein the platform is a metaverse platform.

10. A system for preventing execution of anomalous executables within a cloud computing environment, the system comprising:
a distributed ledger technology (“DLT”) operable to:
receive an electronic indicator of a request transmitted from a mobile device associated with a user;
collect a set of anthropometric data relating to the user and a set of platform data relating to the user; and
verify the set of anthropometric data and the set of platform data;
an artificial intelligence (“AI”) model operable to:
based on the verified data, dynamically generate an algorithm for the user; and
generate, by the algorithm, temporary ephemeral credentials for the user;
a temporary ephemeral vault operable to hold the temporary ephemeral credentials;
a zero-trust data vault that gatekeeps access to the cloud computing system;
wherein:
the temporary ephemeral credentials enable access to the zero-trust data vault for a predetermined session;
the DLT is further operable to:
continuously compare the algorithm to a current set of anthropometric data and a current set of platform data relating to the user, said current set of anthropometric data and current set of platform data being continuously updated;
dynamically evolve the algorithm based on the current set of anthropometric data and the current set of platform data;
the temporary ephemeral vault is further operable:
upon verification of the set of anthropometric data and the set of platform data, enable the user access into the temporary ephemeral vault;
enable the user to access the zero-trust data vault via the temporary ephemeral vault; and
track interactions of the user within the zero-trust data vault;
the DLT and the zero-trust data vault are further operable to dynamically adjust user interactions within the zero-trust data vault based on the continuously compared algorithm to the current set of anthropometric data and the current set of platform data;
the temporary ephemeral vault is securely decommissioned upon termination of the temporary ephemeral vault;
a second DLT operable to:
record feedback data generated by the predetermined session, the feedback data comprising temporary ephemeral credentials, the temporary ephemeral vault and the user interactions; and
based on the feedback data, refine security characteristics of the zero-trust data vault.

11. The system of claim 10 wherein the set of anthropometric data includes measurement of a height of the user, a weight of the user, a waist size of the user and a body mass index (“BMI”) of the user.

12. The system of claim 10 wherein the set of anthropometric data includes biometric data, the biometric data including an iris scan, a fingerprint scan, a retina scan, a facial scan, a keystroke model and a vein recognition scan.

13. The system of claim 10 wherein the temporary ephemeral vault is configured to be securely decommissioned after either a predetermined amount of time or an anomaly detection.

14. The system of claim 10 wherein the user interactions include data access, modifications, real-time behavior analysis and transactions.

15. The system of claim 10 wherein the recording occurs on the second DLT and wherein the second DLT records authentication attempts, vault events and system actions.

16. The system of claim 10 wherein the platform data is digital cosmos platform data.

17. The system of claim 10 wherein the platform data is metaverse platform data.
